(19) United States
(12) Patent Application Publication
(10) Pub. No.: US 2025/0344674 A1
(43) Pub. Date: Nov. 13, 2025

(54) EXTERIOR SQUEAKER FOR TOY

(71) Applicant: Growl USA, Inc., Sacramento, CA (US)

(72) Inventor: Nicholas Watts, Westlake Village, CA (US)

(73) Assignee: Growl USA, Inc., Sacramento, CA (US)

(21) Appl. No.: 19/201,677

(22) Filed: May 7, 2025

Related U.S. Application Data
(60) Provisional application No. 63/643,418, filed on May 7, 2024.

(51) Int. Cl. A01K 15/02; G10K 15/04

(52) U.S. Cl. CPC A01K 15/025; G10K 15/04

(57) ABSTRACT

A pet toy with a squeaker configuration, wherein one or more squeakers are located on or adjacent to the surface of the toy, such that when pressure is applied on the surface of the toy, one or more squeakers are activated and a squeaking sound emanates therefrom. In a preferred embodiment, the toy is filled with material with sufficient density to create a firmness that the squeaker can be compressed against for the squeaker to produce sound. When pressure is applied on the toy surface, a burst of sound emanates from the one or more squeakers.

### CROSS-REFERENCE TO RELATED APPLICATION

This application claims the benefit of U.S. provisional patent application No. 63/643,418, filed on May 7, 2024 and entitled “Exterior Squeaker for Toy.” The contents of the foregoing application are hereby incorporated by reference herein.

### FIELD OF INVENTION

The invention relates generally to toys, particularly a feature or element of toys used by a pet. M ore particularly, it relates to pet toys that incorporate one or more external squeakers that are activated by applying pressure to the toy's surface, thereby attracting a pet to the toy and maintaining the pet's interest in it.

### BACKGROUND

Pet toys are a segment of the pet industry that includes many different options, including functionalities, materials, and purposes. For example, a toy may be is used as an interactive device between the pet and owner, a training tool for pets or just for pure entertainment for the owner and/or the owner's pet. There are also many different types of pet toys on the market that emit sound or that can be used in interactive playtime, such as a tug-of-war game between an owner and a dog, or between two or more dogs without their owner's involvement.

There are many different devices that have been developed to assist pet owners in keeping their pets happy, entertained, or preoccupied. Such devices can be seen in numerous pet stores, online and in brick and mortar stores. Various types of balls, bones, animals, and other such toys can be purchased by the pet owner to be used by their pets for exercise and/or enjoyment. However, pets tend to quickly lose interest in such devices and thus, various toy features have been developed to keep pets entertained.

Noise makers incorporated within pet toys, such as through use of internal bladders or squeakers, are very common. However, no currently known toy has an external squeaker configuration, or is capable of emitting a “squeak” sound when pressure is applied on the surface of the toy.

Pets such as dogs are hunters by nature and are said to instinctively chase after small animals that make sounds. Therefore, they have a tendency to engage in play activities that involve chasing and/or catching objects that emit sound. The novel design of the inventive toy satisfies a pet's instinct to manipulate the toy on its surface such that noise or a sound is emitted in response, simulating its prey. Thus, an object herein is to motivate and maintain interest of a pet by providing a feature that is designed to make sounds in response to a pet's interaction with the toy's surface. This interaction may be through its mouth, paws, snout, or pressure applied from any other body part onto the pet toy surface.

### SUMMARY OF INVENTION

The various embodiments according to the present disclosure overcome the draw backs of known pet toys by providing for a novel configuration comprising one or more squeakers that are located adjacent to the surface of the toy, such that when pressure is applied to the surface of the toy, one or more squeakers is activated and a “squeak” sound emanates therefrom.

In an embodiment of the claimed invention, one or more squeakers are placed underneath the surface of the toy, preferably adjacent to its surface. The center of the toy is filled with filling material such as polyester fill (or “poly fill”), or other filling material with sufficient density or fill to create a firmness or a “backing” that the squeaker can be compressed against for the squeaker to produce sound. A burst of sound emanates from the one or more squeakers when pressure is applied to the toy surface. The squeak sound is emitted either when a squeaker is compressed by direct pressure applied by the pet to that part of the toy surface encompassing a squeaker bladder, or alternatively, by compression of that portion of the toy containing the squeaker(s) onto a hard or firm surface, such as the floor, wall, or any hard or firm object.

In one embodiment of the claimed invention, a toy has squeakers lined up vertically and configured on the surface of the toy animal's body (such as on its chest). In another embodiment, the squeakers are lined up horizontally. In another embodiment, the toy has squeakers or noise makers placed incrementally between breaks preferably within pockets sewn along the body of the toy. In yet another embodiment, a channel within the toy includes a squeaker encapsulated in a pocket sewn into the channel. A second noise maker preferably is encapsulated in a second pocket sewn adjacent to the channel. Multiple squeakers place incrementally on the toy surface can be present in a combination of these different embodiments. In another embodiment, the channel enclosing the squeaker is raised such that the location of the squeaker(s) is visible from viewing the toy surface.

The present invention, however, is not limited to any particular shape, orientation, or number of squeakers, and such one or more squeakers may be placed on any location adjacent to the surface of the toy.

The squeakers utilized in the present invention may be disposed within a chamber or housing provided in a variety of shapes, including a ball, a sphere, a square, a football shape, elongated, or other shapes. When the sound-producing pet toy is in use, external pressure applied to the bladder compresses the bladder against the backing which forces air through the sound device or noise maker. Air forced through the squeaker produces a high-pitched sound, such as a squeak, or the sound of a toy horn or whistle, which is attractive to an animal.

The features of the present invention are not limited to be incorporated into a particular type of toy. The external squeaker(s) of the present invention may be incorporated into virtually any type of pet toy, such as an animal, including, but not limited to a: bird, cat, pig, cow, duck, snake, alligator, lion and a multitude of others. It may also be incorporated into toys that resemble fruits or vegetables. It is additionally to be appreciated that the present invention is not to be understood to be limited to being configured into a portion of an animal body but may be configured or incorporated into any inanimate article, such as a ball, a tree trunk, bone, or simply a cylindrical object, or a three dimensional, raised mat, such as in the shape of a rectangular prism.

Embodiments, examples, features, aspects, and advantages of the present disclosure will become better understood with regard to the following description, appended claims and accompanying drawings.

### BRIEF DESCRIPTION OF THE DRAWINGS

The foregoing aspects and the attendant aspects of the present disclosure will become more readily appreciated by reference to the following detailed description, when taken in conjunction with the accompanying drawings, wherein:

FIG. 1 is a side view of an embodiment of the present invention, with the squeakers on the surface of the toy.

FIG. 2 is a front view of an embodiment of the present invention, wherein the squeakers are visible as part of a raised surface of the toy.

FIG. 3 is an enlarged view of an embodiment of the present invention.

FIG. 4 is a sectional view of an embodiment of the present invention, cut along line 4-4 of the embodiment shown in FIG. 3.

FIG. 5 shows the embodiment in FIG. 4, with pressure being applied on the surface of the toy, causing the squeaker to emit sound.

Reference symbols or names are used in the Figures to indicate certain components, aspects or features shown therein. Reference symbols common to more than one Figure indicate like components, aspects or features shown therein.

### DETAILED DESCRIPTION OF INVENTION

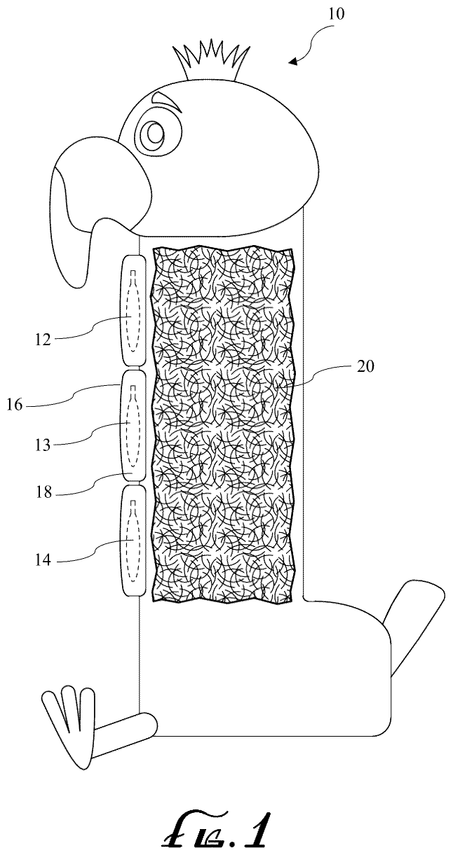

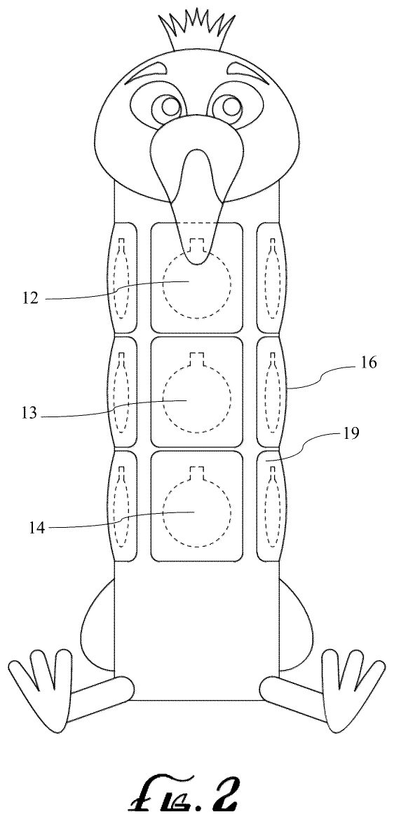

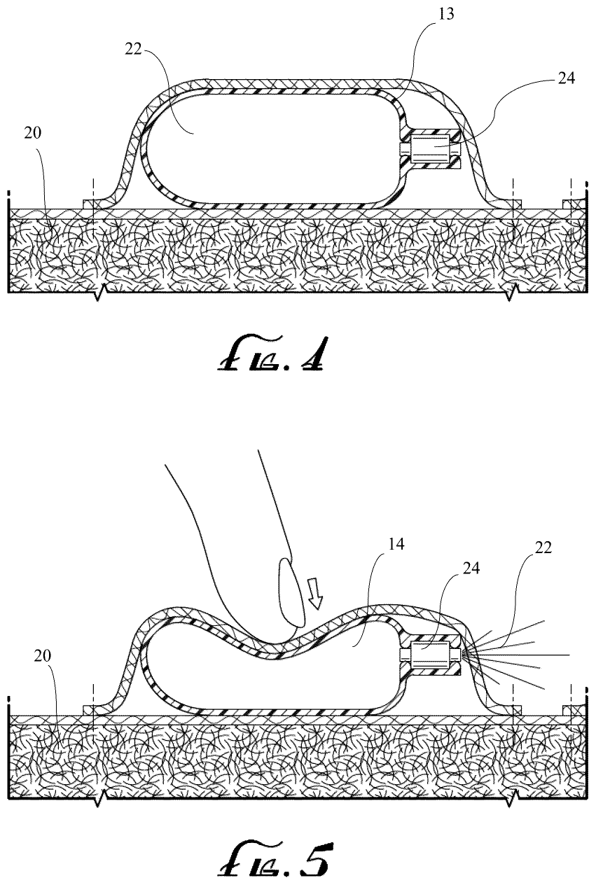

FIGS. 1 and 2 show an exemplary embodiment of a pet toy 10 which, in this case, depicts a parrot. Sound-producing apparatus such as squeakers or bladders 12, 13, and 14 are positioned adjacent to the surface 16 of the toy, within channels or pockets 18 stitched onto or within the toy body. The squeakers or bladders are positioned against a filling 20 of sufficient density, such as poly fill, such that if pressure is applied to the surface 16 of the toy (such as pressure applied by a pet's teeth, paws, or pressure applied by human fingers), such pressure compresses the squeaker or bladder 12, 13, and/or 14, forcing air through a noise maker, or a valve or reed 24 that emits sound (see FIGS. 4 and 5). Thus, the toy will stimulate or attract a pet and, with pressure applied on the surface (as opposed to having to squeeze the entire toy body), will increase the likelihood that the pet will play with the toy.

The pet toy 10 may comprise a soft plush outer shell, and the squeaker or bladder 12, 13, or 14, is disposed adjacent to the outer shell, suspended within the channel or pocket 18, which may contain a filler material 19. The filler material 19 holding the squeaker or bladder may be within the raised pockets or cavity 18 that are stitched onto the body of the toy. The filler material may be made of poly fill, or any material that would help keep the squeaker or bladder in place, or any combination thereof, which may be similar to the material(s) used for the pet toy filler that forms a backing for the squeaker(s).

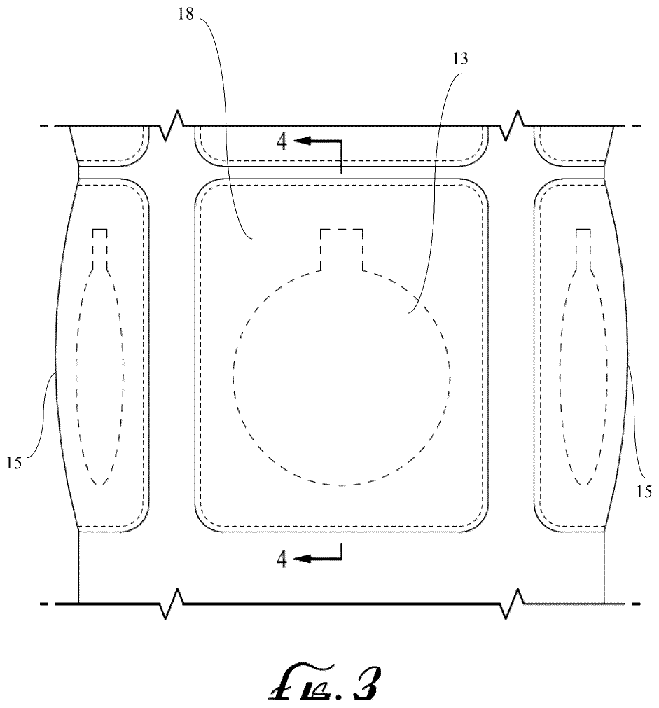

FIG. 3 is an enlarged view of the external squeaker. It illustrates an embodiment of a configuration of the squeakers of the present invention, wherein the location of the squeakers is visible when looking at the surface of the toy. The location of squeakers may be ascertained by the presence of raised portions or areas 15 on the body of the toy. These raised areas will indicate where the squeakers are located under the surface. The raised areas 15 may contain any stitched shape, such as square, rectangular, or a combination of shapes such as rectangular, with a raised area in the center, as shown in the embodiment depicted in FIG. 3.

As shown in FIGS. 4 and 5, the bladders (such as bladder 13 shown in this figure) are filled with air 22 at atmospheric pressure during the resting position of the toy and upon squeezing or compression air is forced out of the valve or reed 24, causing sound, typically a high-pitched squeak, to be created.

As shown in FIG. 5, the bladder contains air, and when the toy is compressed on its the surface, such compresses the air within the bladder against a distal or back wall of the bladder, and against the backing or fill 20, thereby forcing air out of the bladder through the whistle or reed 24, creating an attractive noise for the pet. When the pressure is released, the bladder is able to expand, filling the bladder with air. Thus, the process may be repeated wherein pressure is placed onto the toy surface where the bladder is located. This alternating pressure allows for compressing and expanding of the bladder producing an attractive noise or sound for pets. The toy is able to provide both entertainment and exercise to the family pet, and with the external squeaker feature, will provide continued interest and additional entertainment to the pet.

The fill 20 inside the toy may be comprised of resilient filler material such as polyester fiberfill blend made from polyester fibers, preferably of density to serve as a “backing” to the one or more squeakers on the toy surface, so that when pressure is applied to the squeaker, sound is produced. The optimal density will depend upon the fill material, and the type and shape of toy that is used. Other filling may be used such as acrylic, wool, fabric scraps, cotton, bamboo, paper, recycled cushions, beads, polystyrene, or any combination thereof, with density sufficient to serve as a backing so that sound is produced when pressure is applied to the surface of the toy.

In other embodiments, alternative or additional materials may be utilized, such as a stiff material (e.g., cardboard or plastic) to form the internal “backing” (or part thereof) on which the squeaker would compress against to produce a sound.

The compression of the squeaker or bladder 12, 13, 14 forces air through the reed or valve 24 thus producing a sound. The bladder may be manufactured from an elastomer such as latex or other polymer that allows the bladder to expand and contract. These materials include, but are not limited to, plastic, synthetic rubber, or any combination of two or more rubber-like materials such as TPE and its variants. The reed or valve 24 may be manufactured from a resilient material such as metal or plastic and is shaped in such a way as to produce a noise when air is blown through it. Sound-producing parts or components known in the art may be used.

The toy outer shell may be manufactured from a pliable material such as naturally produced fabrics including cotton, wool, felt or synthetically produced fabrics including faux fur or polyester. The filler material within the body of the toy creates an effect that is tactilely pleasing and dampens some of the forces transferred to the sound-producing apparatus, but is of sufficient density or fill for the bladder or squeaker to be compressed against. The pet toy is preferably constructed of materials that are durable; but the toy can use different materials in different sections for better construction and durability. For example, the outer layer or skin may be made of any durable or pliable material that resists damage from being chewed by an animal.

The squeaker or bladder configuration of the present invention may be positioned anywhere on the toy. In one embodiment of the claimed invention, a toy has the squeakers lined up vertically and configured on the toy animal's body (such as on a bird's chest), as depicted in FIG. 1. The toy may also have squeakers or noise makers placed incrementally between breaks sewn along the body of the toy, as shown in FIGS. 2 and 3.

Additional bladders may be positioned in other locations along the surface of the toy. Bladders or squeakers may be placed adjacent to the surface of the pet toy's chest or belly (if it is an animal), or anywhere around its body. Although specific embodiments of the disclosure have been described, various modifications, alterations, alternative constructions, and equivalents are also encompassed within the scope of invention as set forth in the claims.

The specification and drawings are, accordingly, to be regarded in an illustrative rather than a restrictive sense. It will, however, be evident that additions, subtractions, deletions, and other modifications and changes may be made thereunto without departing from the broader spirit and scope of invention as set forth in the claims.

While only an illustrated embodiment of the present invention has been disclosed for purposes of illustration, it is to be appreciated that many modifications and variations could be made thereto. It is intended to cover all of those modifications and variations which fall within the scope of the present invention, as defined by the following claims.

1. A pet toy comprising:
a surface and a body;
a pocket underneath the surface;
a sound-producing apparatus disposed within the pocket;
wherein the sound-producing apparatus comprises a bladder;
a backing within the pet toy body;
wherein when external pressure is applied to the pocket, sound is produced by the bladder.

2. The pet toy of claim 1, wherein the backing is comprised of polyester fill in the toy body, adjacent to the pocket.

3. The pet toy of claim 1, wherein the pocket forms a raised area on the surface of the pet toy.

4. The pet toy of claim 1, wherein the pocket contains a filler material.

5. The pet toy of claim 1, further comprising a second sound-producing apparatus encapsulated in a second pocket.

6. The pet toy of claim 1, further comprising a second, third, and fourth sound-producing apparatus, encapsulated in a second, third, and fourth pocket, respectively.

7. The pet toy of claim 1, wherein the toy resembles an animal.

8. The pet toy of claim 6, wherein the sound-producing apparatus are lined up incrementally along the surface of the pet toy.

9. A pet toy comprising:
a body and a surface surrounding the body;
a first chamber sized to contain a squeaker;
a second chamber sized to contain a second squeaker, wherein the second chamber is isolated from the first chamber;
wherein the first chamber and the second chamber are disposed underneath the surface, adjacent to the surface of the pet toy;
wherein the first and second chambers are each sized and contain a material that provides compressible reaction that activates the first and second squeakers when pressure is applied onto the surface of the toy adjacent to where the first and second squeakers are located.

10. The pet toy of claim 9, wherein the first and second chambers each form a raised area on the surface of the pet toy.

11. The pet toy of claim 9 wherein the body contains a filler of sufficient density to create a firmness such that sound is produced by the first and second squeakers when pressure is applied onto the surface of the toy adjacent to where the first and second squeakers are located.

12. The pet toy of claim 9 wherein the toy resembles an animal.

13. The pet toy of claim 9 further comprising a third squeaker within a third chamber.

14. The pet toy of claim 13 wherein the first, second, and third squeakers are lined up vertically along the pet toy.

15. The pet toy of claim 14 wherein the first, second, and third squeakers are lined up horizontally along the pet toy.

16. A toy comprising;
a pocket, having a front side and a back side;
a squeaker that is disposed within the pocket, wherein the squeaker has a hollow cavity;
a backing adjacent to the back side of the pocket, wherein the backing comprises a filler of sufficient density and firmness such that when the toy is against a surface, and external pressure is applied to the front side of the pocket, the squeaker is activated by air moving through it, into and out of the hollow cavity, as external pressure is applied and released.

17. The toy of claim 16 wherein the pocket forms a raised area on the toy.

18. The toy of claim 16, further comprising a second squeaker disposed within a second pocket and a third squeaker disposed within a third pocket.

19. The toy of claim 16 wherein the pocket contains a filler material.

20. The toy of claim 18 wherein the first, second, and third squeakers are disposed incrementally on the toy.
